(19) United States
(12) Patent Application Publication
(10) Pub. No.: US 2021/0154576 A1
(43) Pub. Date: May 27, 2021

(54) VECTOR GRAPHICS-BASED LIVE STREAMING OF VIDEO GAMES

(71) Applicant: DOT LEARN INC., Edison, NJ (US)

(72) Inventors: Samrat Bhattacharyya, Edison, NJ (US); Krishna Savant Syreddy, Telangana (IN); Avijit Kundal, Bengaluru (IN)

(21) Appl. No.: 17/102,527

(22) Filed: Nov. 24, 2020

Related U.S. Application Data
(60) Provisional application No. 62/941,296, filed on Nov. 27, 2019.

(51) Int. Cl. A63F 13/355

(52) U.S. Cl. CPC A63F 13/355; A63F 2300/538; A63F 2300/572

(57) ABSTRACT

Techniques for vector graphics-based live streaming of video games are disclosed. While a video game is executing on a user device, a live streaming server receives a set of unrendered vector graphics data that encodes three-dimensional graphics of the video game. The live streaming server transmits the set of unrendered vector graphics data to a live streaming client.

### RELATED APPLICATIONS

This application claims the benefit of U.S. Provisional Patent Application Ser. No. 62/941,296, titled “Vector Graphics-Based Live Streaming of Video Games,” filed Nov. 27, 2019, which is hereby incorporated by reference.

### BACKGROUND

In video game live streaming, video game players (sometimes referred to as “live streamers”) capture live video of their video game sessions. The live video is broadcast, via live streaming servers, to viewers who may be located in many different places around the world. Video game live streaming is a popular segment of online video, with services like Twitch and YouTube Live having hundreds of millions of viewers per month and growing rapidly.

Typically, to live stream a video game session, a software program on the live streamer's computer system records the screen while the live streamer is playing the video game. Specifically, the software program takes screen captures of pixel graphics generated by the operating system, and generates a live video stream of the screen captures in a pixel-based video format. The live streamer's computer system transmits the pixel-based video to a live streaming server, which transcodes the pixel-based video into multiple compressed pixel-based video streams of different resolutions and qualities (e.g., using compression technologies such as H.264 encoding). The live streaming server broadcasts the compressed pixel-based video streams to live streaming clients through one or more content delivery networks (CDNs). Live streaming clients display the live streams using client-side software (e.g., a web browser) that supports playback of streaming pixel-based video.

Live streaming can be resource intensive. For example, considerable bandwidth is needed to broadcast live streams to large numbers of live streaming clients. Live streaming platforms may pay upwards of $100 million per year to CDNs and other cloud infrastructure providers. Typically, there is a trade-off between latency and video quality. Efforts to reduce bandwidth needs for live streaming have focused on incremental improvements in pixel-based video compression technology. Such improvements are able to marginally reduce the size of the pixel-based video and/or improve video quality at a given bitrate. Some live streams use adaptive technology that adjusts the bitrate of pixel-based video based on the available bandwidth.

Approaches described in this section have not necessarily been conceived and/or pursued prior to the filing of this application. Accordingly, unless otherwise indicated, approaches described in this section should not be construed as prior art.

### SUMMARY

One or more embodiments transmit vector graphics data to live streaming clients, instead of pixel-based video. Transmitting vector graphics data may use less network bandwidth than transmitting pixel-based video. For a given frame or sequence of video, vector graphics data is typically smaller (i.e., occupies fewer bytes of data) than pixel-based video. Thus, one or more embodiments may reduce outgoing (i.e., upload) bandwidth requirements for the live streaming server. Reducing outgoing bandwidth requirements may also reduce the cost of operating the live streaming server (e.g., CDN and/or other cloud infrastructure costs). The cost savings may be substantial, for example, if the live streaming server broadcasts to many live streaming clients. Meanwhile, one or more embodiments retain the flexibility to stream pixel-based video as needed or requested.

In addition, one or more embodiments may reduce incoming (i.e., download) bandwidth requirements for one or more live streaming clients. Reducing incoming bandwidth requirements may reduce the cost of Internet access for the live streaming client, and/or may free up download bandwidth for other uses. Moreover, because vector graphics data is the same regardless of target graphics resolution, increased video quality does not require a trade-off in network latency. When a live streaming client receives vector graphics data, the live streaming client may render video using a configuration that is suited to the live streaming client's specific configuration (e.g., GPU capability, pixel resolution, etc.). Thus, rendering pixel-based video at the live streaming client, based on scalable vector graphics data, may improve the visual quality of the live stream for the live streaming client, without a corresponding trade-off in network latency.

In addition, one or more embodiments may reduce outgoing bandwidth requirements for a live streamer. Specifically, the live streamer's device transmits vector graphics data to a live streaming server, rather than pixel-based video. Reducing outgoing bandwidth requirements may reduce the cost of Internet access for the live streamer and/or free up upload bandwidth for other uses. In some cases, reducing the bandwidth needed for live streaming helps avoid saturating the live streamer's upload connection, which may help prevent lag in networked multiplayer video games and thereby improve the live streamer's chances of success in the video game.

In general, in one aspect, one or more non-transitory computer-readable media store instructions that, when executed by one or more processors, cause a live streaming server to receive, while a video game is executing on a user device, a first set of unrendered vector graphics data that encodes three-dimensional graphics of the video game. The live streaming server transmits the first set of unrendered vector graphics data to a first live streaming client.

In general, in one aspect, a system includes at least one device including a hardware processor. The system is configured to perform operations including: receiving, by a live streaming server while a video game is executing on a user device, a first set of unrendered vector graphics data that encodes three-dimensional graphics of the video game; and transmitting, by the live streaming server, the first set of unrendered vector graphics data to a first live streaming client.

In general, in one aspect, a method includes: receiving, by a live streaming server while a video game is executing on a user device, a first set of unrendered vector graphics data that encodes three-dimensional graphics of the video game; and transmitting, by the live streaming server, the first set of unrendered vector graphics data to a first live streaming client, wherein the method is performed by at least one device including a hardware processor.

In an embodiment, prior to transmitting the first set of unrendered vector graphics data to the first live streaming client, the live streaming server transpiles the first set of unrendered vector graphics data from a received data format to a normalized data format.

In an embodiment, a set of compiled code may be installed on the user device that is configured to intercept unrendered vector graphics data in calls to a graphics library. The set of compiled code may include a modified version of at least part of the graphics library.

In an embodiment, the first set of unrendered vector graphics data is intercepted in a call to a graphics library on the user device. Responsive to intercepting the first set of unrendered vector graphics data, the first set of unrendered vector graphics data is transmitted from the user device to the live streaming server.

In an embodiment, the video game is executing, the live streaming server receives a second set of unrendered vector graphics data that encodes two-dimensional elements of a user interface of the user device. The live streaming server transmits the second set of unrendered vector graphics data to the first live streaming client. Prior to transmitting the second set of unrendered vector graphics data to the first live streaming client, the live streaming server may transpile the second set of unrendered vector graphics data from a received data format to a normalized data format. Prior to transmitting the first set of normalized unrendered vector graphics data and the second set of normalized unrendered vector graphics data to the first live streaming client, the live streaming server may aggregate the first set of unrendered vector graphics data and the second set of unrendered vector graphics data. The second set of unrendered vector graphics data may be intercepted in a call to a graphics library on the user device. Responsive to intercepting the second set of unrendered vector graphics data, the second set of unrendered vector graphics data is transmitted from the user device to the live streaming server.

In an embodiment, a patch to the video game is installed. The patch includes a set of compiled code configured to transmit the set of unrendered vector graphics data generated by the video game to the live streaming server.

In an embodiment, while the video game is executing, the live streaming server renders a video in a pixel-based format based at least on the first set of unrendered vector graphics data. The live streaming server transmits the video in the pixel-based video format to a second live streaming client for viewing. While the video game is executing, the live streaming server may receive a second set of unrendered vector graphics data that encodes two-dimensional elements of a user interface of the user device. Rendering the video in the pixel-based format may be further based on the second set of unrendered vector graphics data, such that the video in the pixel-based format simultaneously depicts the three-dimensional graphics of the video game and the two-dimensional elements of the user interface. Transmitting the first set of unrendered vector graphics data to the first live streaming client may be based at least on a first client attribute associated with the first live streaming client, and transmitting the video in the pixel-based format to the second live streaming client may be based at least on the second client attribute associated with the second live streaming client. The first client attribute may indicate a first rendering capability of the first live streaming client and the second client attribute may indicate a second rendering capability of the second live streaming client.

In an embodiment, a format-switching condition associated with the first live streaming client is detected. Responsive to detecting the format-switching condition, video in a pixel-based video format is transmitted to the first live streaming client instead of unrendered vector graphics data.

One or more embodiments described in this Specification and/or recited in the claims may not be included in this General Overview section.

### BRIEF DESCRIPTION OF THE DRAWINGS

Various aspects of at least one embodiment are discussed below with reference to the accompanying Figures, which are not intended to be drawn to scale. The Figures are included to provide illustration and a further understanding of the various aspects and embodiments, and are incorporated in and constitute a part of this specification, but are not intended to define the limits of the disclosure. In the Figures, each identical or nearly identical component that is illustrated in various Figures is represented by a like numeral. For the purposes of clarity, some components may not be labeled in every figure. In the Figures:

FIG. 1 is a block diagram of an example of a system according to an embodiment;

FIG. 2 is a flow diagram of an example of operations for vector graphics-based live streaming of video games according to an embodiment; and

FIG. 3 is a block diagram of an example of a computer system according to an embodiment.

### DETAILED DESCRIPTION

The following table of contents is provided for the reader's convenience and is not intended to define the limits of the disclosure.

1. SYSTEM ARCHITECTURE

2. VECTOR GRAPHICS-BASED LIVE STREAMING OF VIDEO GAMES

3. MISCELLANEOUS; EXTENSIONS

4. COMPUTING DEVICES

5. COMPUTER NETWORKS

1. System Architecture

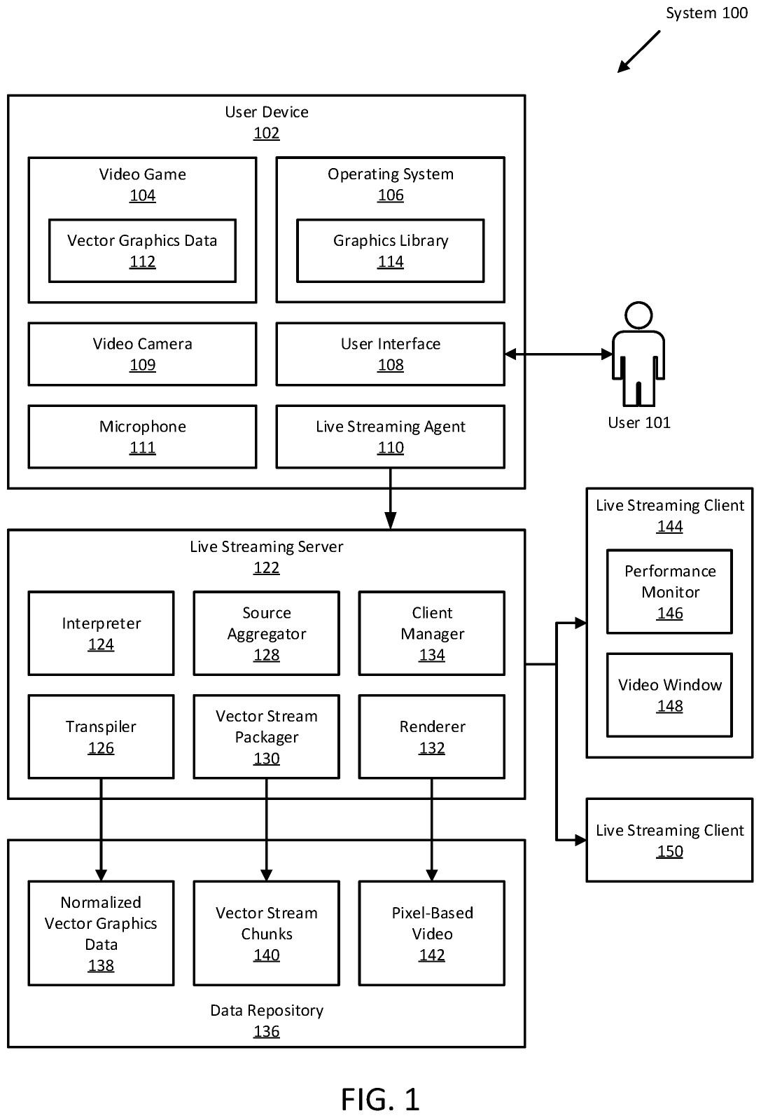

FIG. 1 is a block diagram of an example of a system 100 according to an embodiment. In an embodiment, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

In an embodiment, a user device 102 refers to hardware and/or software configured to execute a video game 104. For example, the user device 102 may be a personal computer (e.g., a laptop or desktop computer system running a Windows®, macOS®, or Linux operating system), a mobile device such as a tablet or smartphone, or another kind of device. The video game 104 may be a single-player video game or a multiplayer video game (which may also include a single-player mode). For example, the video game 104 may be a multiplayer video game configured to connect to an esports (also referred to as electronic sports, e-sports, or eSports) network, to allow a user to participate in an online video game match or competition. As of the date of this application, popular esports video games include, but are not limited to: Fortnite; League of Legends; Dota 2; Overwatch; Hearthstone; Counter-Strike: Global Offensive; Players Unknown Battleground (PUBG); World of Warcraft; Apex Legends; and Mortal Kombat 11. Many different single-player and multiplayer video games exist.

In an embodiment, the video game 104 is configured to generate vector graphics data 112. The vector graphics data 112 encodes three-dimensional graphics of the video game 104 (i.e., three-dimensional graphics presented, on an ongoing basis, to a user playing the video game 104) in a vector graphics format. A vector graphics format defines images in terms of points that are connected by lines and curves to form polygons and other shapes. Some vector graphics formats support vector-based text, color gradients, complex objects defined as primitives, and/or other vector-based graphical elements. Vector graphics can be scaled to any display size without any loss in visual quality, except as constrained by the display itself (e.g., due to a pixel resolution of the display). In contrast, raster graphics formats such as Portable Network Graphics (PNG), Joint Photographic Experts Group (JPEG), etc., are pixel-based and may lose quality upon rescaling, even on high-resolution displays. Some examples of vector graphics formats include, but are not limited to: Scalable Vector Graphics (SVG); Adobe Illustrator Artwork (AI); vector Portable Document Format (PDF); and Encapsulated Postscript (EPS). The video game 104 is configured to generate vector graphics data 112 on an ongoing basis, as gameplay progresses. Thus, some or all of the vector graphics data 112 may be different from one moment of gameplay to the next. The vector graphics data 112 may also be referred to as “raw” or “unrendered” vector graphics data.

In an embodiment, an operating system 106 includes a graphics library 114. The graphics library 114 includes one or more application programming interfaces (APIs) that software programs (e.g., the video game 104) use to render graphics in a user interface 108 of the user device 102. For example, the operating system 106 may be a Microsoft Windows® operating system and the graphics library 114 may be a version of Microsoft DirectX®, which is stored as a dynamically linked library (DLL). Microsoft DirectX® includes a Direct2D API for rendering two-dimensional graphics and a Direct3D® API for rendering three-dimensional graphics. Other graphics libraries may be used. For example, macOS® operating systems may include OpenGL and/or Metal graphics libraries. Accordingly, while examples are given herein with reference to Microsoft DirectX®, embodiments are not limited to using Microsoft DirectX®. The video game 104 supplies the vector graphics data 112 to the graphics library 114 in one or more API calls (e.g., one or more calls to the Direct3D® API). The graphics library 114 renders three-dimensional graphics of the video game 104, based on the vector graphics data 112 supplied by the video game 104.

In an embodiment, in addition to three-dimensional graphics of the video game 104, the user interface 108 displays two-dimensional elements. Two dimensional elements of the user interface 108 may include, but are not limited to: windows and associated window controls; icons; and text (e.g., icon text, a chat interface, etc.). The graphics library 114 may receive vector graphics data (not shown) that encodes two-dimensional elements of the user interface 108. Vector graphics data that encodes two-dimensional elements of the user interface 108 may be in the same format or in a different format than the vector graphics data 112 that encodes three-dimensional graphics of the video game 104. Vector graphics data that encodes two-dimensional elements of the user interface 108 may be generated by the video game 104, the operating system 106 itself (e.g., by a windowing system of the operating system 106), and/or another software application (not shown) executing on the user device 102. The graphics library 114 receives the vector graphics data in one or more API calls (e.g., one or more calls to the Direct2D API) and renders two-dimensional graphics based on the vector graphics data. The user interface 108 may simultaneously display both the three-dimensional graphics of the video game and the two-dimensional elements.

In an embodiment, one or more hardware and/or software components of the user device 102 is/are configured to generate pixel-based video of a user 101 of the user device 102. For example, the user device 102 may include or be connected to a video camera 109 configured to capture video of the physical environment, such as the user 101's face. In addition, the user device 102 may include or be connected to a microphone 111 configured to capture audio from the physical environment, such as the user 101's voice. The user device 102 may receive audiovisual data from the video camera 109 and/or microphone 111, and generate pixel-based video based on the audiovisual data. For ease of discussion, without limiting one or more embodiments, pixel-based video generated based on audiovisual data from a video camera 109, optionally including audio from a microphone 111, is referred to herein as “webcam video.” The user device 102 may present webcam video in the user interface 108. Alternatively, the user device 102 may generate webcam video to be included in a live stream, without presenting the webcam video in the user interface 108.

In an embodiment, a live streaming agent 110 refers to hardware and/or software configured to intercept the vector graphics data 112 generated by the video game 104 and transmit the vector graphics data 112 from the user device 102 to a live streaming server 110. To intercept the vector graphics data 112, the live streaming agent 110 may be configured, for example, to copy the vector graphics data 112 or obtain a reference to a memory location storing the vector graphics data 112. The live streaming agent 110 may be configured to intercept the vector graphics data 112 at any point after the video game 104 generates the vector graphics data 112. Intercepting the vector graphics data 112 does not prevent transmission of the vector graphics data 112 to the graphics library 114. In addition, intercepting the vector graphics data 112 may require such little computing overhead that any delays introduced by the live streaming agent 110 are not discernible to a user 101 of the video game 104. Avoiding discernable delays may be important, for example, in certain esports settings where processing delays might provide a competitive edge to the user 101's adversaries. The live streaming agent 110 may be configured to similarly intercept other vector graphics data (e.g., vector graphics data that encodes two-dimensional elements of the user interface 108). In addition, the live streaming agent 110 may be configured to obtain webcam video generated during a video game session.

In one example, to intercept the vector graphics data 112, the live streaming agent 110 includes a patch (i.e., a plug-in or replacement code) to the video game 104. The patch may modify a segment of the video game 104's code that is configured to make calls to the graphics library 114. When the video game 104 makes a call to the graphics library 114, the modified code intercepts the vector graphics data 112 included in the call, while also allowing the video game 104 to complete the call to the graphics library 114.

In another example, to intercept the vector graphics data 112, the live streaming agent 110 includes a modified version of the graphics library 114. If the graphics library 114 is Microsoft DirectX®, the live streaming agent 110 may include a modified version of directx.dll. When the graphics library 114 receives a call from the video game 104, the modified code intercepts the vector graphics data 112 included in the call, while also allowing the graphics library 114 to render graphics based on the vector graphics data 112.

In an embodiment, a live streaming server 122 refers to hardware and/or software configured to broadcast live streams (i.e., real-time video broadcasts) of three-dimensional video game graphics to one or more live streaming clients (e.g., live streaming clients 144, 150). Specifically, the live streaming server 122 is configured to receive vector graphics data 112 that encodes three-dimensional graphics of the video game 104 and broadcast one or more live streams based on the vector graphics data 112. In an embodiment, the live streaming server 122 is configured to broadcast at least one live stream in a vector graphics format. The live streaming server 122 may also be configured to broadcast one or more live streams in other formats (e.g., other vector graphics formats and/or pixel-based video formats), to accommodate different kinds and/or configurations of live streaming clients. In addition, the live streaming server 122 may be configured to broadcast webcam video obtained from the user device 102. The live streaming server 122 may broadcast live streams as part of, or in association with, a live streaming service such as Twitch®, YouTube Live, Facebook Live, Periscope, and/or another live streaming service.

In an embodiment, an interpreter 124 refers to hardware and/or software configured to interpret incoming vector graphics data 112, to determine which operations are needed to broadcast a live stream based on the vector graphics data 112. Data from different sources may require different operations. The operations needed to broadcast a live stream based on the vector graphics data 112 may depend on a configuration or property of the user device 102, such as the operating system 106, one or more hardware components, and/or another configuration or property of the user device 102 or combination thereof. For example, if the user device 102 is Microsoft Windows®-based computer system, the interpreter 124 may determine that a Microsoft Windows®-aware (context-specific) graphics engine is needed to transpile the incoming vector graphics data 112 to a normalized (context-independent) vector graphics format.

In an embodiment, the live streaming server 122 is configured to broadcast a live stream in one or more particular vector graphics formats. A vector graphics format that the live streaming server 122 uses to broadcast live streams is referred to herein as a normalized vector graphics format, because it provides a consistent format expected by live streaming clients. Vector graphics data received in other vector graphics formats may need to be normalized, i.e., transpiled to a normalized vector graphics format. A transpiler 126 refers to hardware and/or software configured to generate normalized vector graphics data 138 by transpiling vector graphics data from a received vector graphics format to a normalized vector graphics format. The live streaming server 122 may include multiple transpilers 126, each configured to transpile vector graphics data from one or more received vector graphics formats to one or more normalized vector graphics formats. Alternatively or additionally, the live streaming server 122 may receive vector graphics data that is already in a normalized vector graphics format.

In an embodiment, the live streaming server 122 is configured to broadcast a live stream based on a combination of multiple sets of vector graphics data from different sources (e.g., one set of vector graphics data 112 that encodes three-dimensional graphics of the video game 104, and another set of vector graphics data that encodes two-dimensional elements of the user interface 108). A source aggregator 128 refers to hardware and/or software configured to aggregate two or more sets of vector graphics data. The source aggregator 128 may be configured to aggregate vector graphics data as received and/or normalized vector graphics data 138 generated by the transpiler 126.

In an embodiment, a vector stream packager 130 refers to hardware and/or software configured to package vector graphics data (e.g., as received and/or normalized) for transmission to live streaming clients. Specifically, the vector stream packager 130 may be configured to segment vector graphics data into time-interval segments, referred to here as vector stream chunks 140. The vector stream packager 130 may package the vector stream chunks 140 into a streaming format that is capable of streaming arbitrary chunked data (e.g., text, audio, and/or video data). For example, the vector stream packager 130 may package the vector stream chunks 140 into Dynamic Adaptive Streaming over HTTP (DASH), HTTP Live Streaming (HLS), and/or another streaming format.

In an embodiment, a live streaming client 144 is configured to receive vector graphics data (e.g., vector stream chunks 140) in a live stream and render video based on the vector graphics data. The live-streaming client 144 may render the video on a vector overlay (e.g., a WebGL overlay or another kind of vector overlay) over a video display element in a video window 148. A user of the live-streaming client 144 is thus able to view video of the video game 104, without requiring transmission of a pixel-based video from the live streaming server 122 to the live streaming client 144.

In an embodiment, when broadcasting a live stream in vector graphics format, the live streaming server 122 is also configured to broadcast pixel-based webcam video. The vector-based stream may effectively broadcast the vector graphics data and pixel-based webcam video in parallel. When the live streaming client 144 processes the vector graphics data, the live streaming client 144 may also obtain the webcam video, for example via a reference to the webcam video in the vector graphics data. The live streaming client 144 may include the pixel-based webcam video as part of the rendered video, i.e., generate a single rendered video based on the unrendered vector graphics data and the pixel-based webcam video. Alternatively, the live streaming client 144 may keep the webcam video as a separate video stream. Whether included in the rendering process or kept as a separate video stream, the live streaming client 144 may present the webcam video as an overlay of the rendered video (e.g., in a picture-in-picture (PIP) or other overlay configuration), or in a different visual region of the video window 148 such as a different window and/or on a different display.

In an embodiment, in addition to broadcasting at least one live stream in a vector graphics format, the live streaming server 122 is configured to broadcast one or more live streams in a pixel-based video format. A renderer 132 refers to hardware and/or software configured to render a pixel-based video 142 based on vector graphics data (e.g., using one or more H.264 encoders and/or another kind of encoder). The live streaming server 122 may include multiple renderers 132, each configured to render a different type of pixel-based data. One or more renderers 132 may be configured to render multiple pixel-based video formats (e.g., using different codecs and/or bitrates), to accommodate different kinds and/or configurations of live streaming clients. In addition, a renderer 132 may be configured to integrate webcam video (e.g., as PIP, adjacent video, and/or another visual configuration) with pixel-based video rendered based on vector graphics data. Alternatively, when live streaming pixel-based video, the live streaming server 122 may also broadcast webcam video as a parallel pixel-based video stream. The live streaming server 122 may be configured to transcode webcam video to multiple formats (e.g., different codecs and/or bitrates), to accommodate different kinds and/or configurations of live streaming clients.

In an embodiment, the live streaming server 122 is configured to broadcast live streams in different formats to different live streaming clients. For example, the live streaming server 122 may broadcast a live stream of a video game session in vector graphics format to live streaming client 144 and a live stream of the same video game session in a pixel-based video format to live streaming client 150. A client manager 134 refers to hardware and/or software configured to determine which format of live stream to broadcast to each live streaming client. The particular format broadcast to a particular client may depend on many different factors. For example, the format may depend on one or more properties associated with the live streaming client (e.g., operating system, web browser type, graphics processing unit (GPU) type, Internet connection speed or lag, and/or another property or combination thereof). The client manager 134 may be configured to broadcast a live stream using whatever format a live streaming client requests. For example, a live streaming client 144 may include a module or function that detects when a vector-based streaming format is available, and request that format when available, optionally dependent on a user-specified preference. Alternatively, the client manager 134 may be configured to initially attempt live streaming using a particular default format (e.g., a vector graphics format).

In an embodiment, when the live streaming server 122 is broadcasting to a particular live streaming client, the client manager 134 may switch from a live stream in one format to a live stream in another format. Switching formats may be performed responsive to detecting a format-switching condition. As one example, the client manger 134 may detect that a live streaming client 144 is unresponsive or slow to respond, and switch to a lower-bitrate format based a presumption that the live streaming client 144 is experiencing degraded network performance. Alternatively, the client manager 134 may receive a request from the live streaming client 144 to switch formats, based on a user-specified preference and/or a performance issue detected at the live streaming client 144.

In an embodiment, a live streaming client 144 includes a performance monitor 146. The performance monitor 146 is configured to monitor the live streaming client 144's handling of a live stream provided by the live streaming server 122. For example, when live streaming to a web browser, the performance monitor 146 may execute within the web browser (e.g., as a JavaScript library and/or other code that executes within a web browser) and monitor video playback within the web browser. The performance monitor 146 may monitor rendering performance at the live streaming client 144 (i.e., rendering of pixel-based video based on vector graphics data included in the live stream), frame rates of video playback in a video window 148, and/or another metric or combination thereof associated with the live streaming client 144's handling of the live stream. If performance is insufficient according to a predefined rule or metric (e.g., the live streaming client 144 exceeds a threshold CPU utilization or playback in the video window 148 falls below a minimum frame rate), the performance monitor 146 may request a different format of live stream from the live streaming server 122. For example, if the live streaming client 144 lacks the GPU features or otherwise struggles to render pixel-based video based on vector graphics data at a sufficient rate, the performance monitor 146 may request a live stream in a pixel-based video format. Pixel-based video requires more network bandwidth to transfer from the live streaming server 122 to the live streaming client 144, but less processing power to view at the live streaming client 144, because the live streaming client 144 does not need to render the video. If performance improves while streaming pixel-based video, the performance monitor 146 may request a switch to a vector-based streaming format. Switching a live stream from vector graphics data to a pixel-based video format, or vice versa, may be referred to as “adaptive codec switching.”

In an embodiment, one or more components of the system 100 are implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (“PDA”), a wireless receiver and/or transmitter, a base station, a communication management device, a router, a switch, a controller, an access point, and/or a client device.

2. Vector Graphics-Based Live Streaming of Video Games

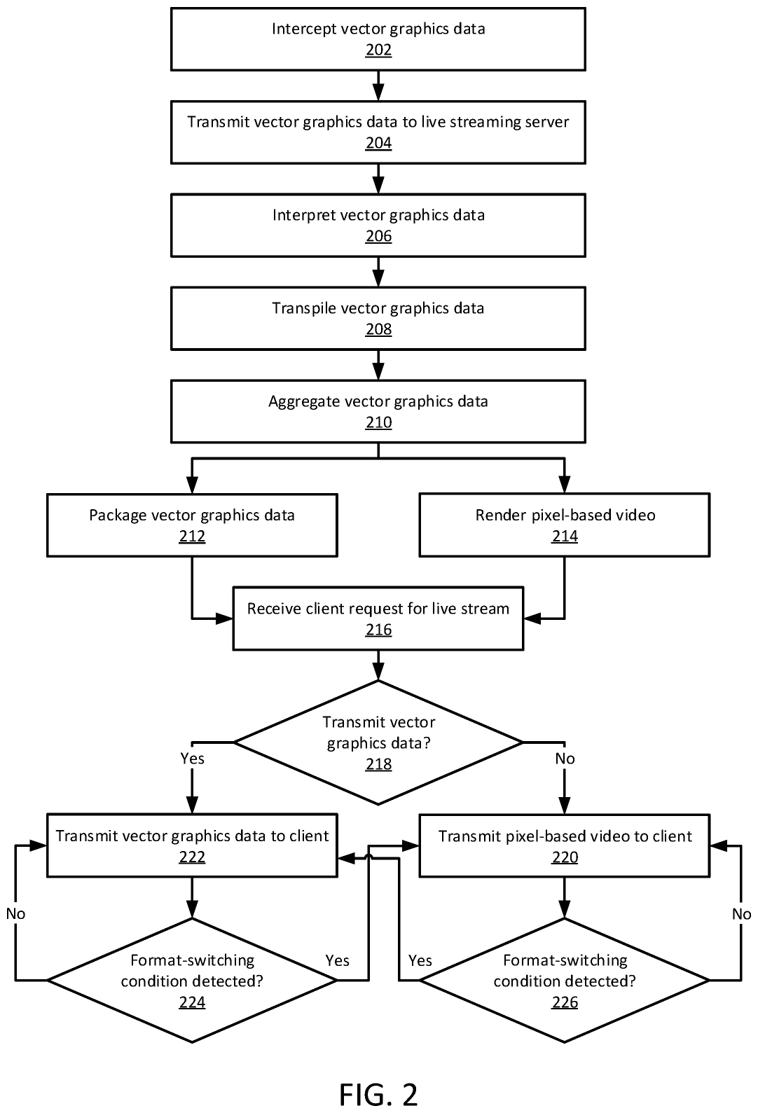

FIG. 2 is a flow diagram of an example of operations for vector graphics-based live streaming of video games according to an embodiment. One or more operations illustrated in FIG. 2 may be modified, rearranged, or omitted all together. Accordingly, the particular sequence of operations illustrated in FIG. 2 should not be construed as limiting the scope of one or more embodiments.

In an embodiment, a live streaming agent intercepts vector graphics data (Operation 202), generated on a user device, that encodes three-dimensional graphics of a video game. As discussed above, the live streaming agent may intercept vector graphics data in many different ways, such as a patch to the video game and/or a modified version of a graphics library. In addition, the live streaming agent may intercept other vector graphics data, such as vector graphics data that encodes two-dimensional elements of a user interface.

In an embodiment, the live streaming agent transmits the vector graphics data from the user device to a live streaming server (Operation 204). The live streaming server may interpret the vector graphics data (Operation 206). If the vector graphics data is not in an vector graphics format that the live streaming server uses to broadcast live streams, the live streaming server may transpile the vector graphics data into a normalized vector graphics format (Operation 208), thus generating normalized vector graphics data.

In an embodiment, a live stream includes graphics from multiple sources. As part of generating the live stream, the live streaming server may aggregate vector graphics data from multiple sources (Operation 210). For example, the live streaming server may aggregate (a) vector graphics data that encodes three-dimensional graphics of the video game and (b) vector graphics data that encodes two-dimensional user interface elements.

In an embodiment, the live streaming server packages vector graphics data for live streaming (Operation 212). For example, as described above, the live streaming server may generate vector stream chunks and package the vector stream chunks into a streaming format that is capable of streaming arbitrary chunked data (e.g., text, audio, and/or video data).

In an embodiment, the live streaming server renders pixel-based video based on vector graphics data received from the user device (Operation 214). The live streaming server may render a single format of pixel-based video or multiple formats of pixel-based video (e.g., using multiple codecs and/or bitrates), to accommodate different live streaming clients.

In an embodiment, the live streaming server receives a client request for a live stream of the video game (Operation 216). The live streaming server determines whether to transmit vector graphics data to the live streaming client (Operation 218). Determining whether to transmit vector graphics data to a live streaming client may be based on many different factors. As one example, the live streaming server may obtain one or more attributes associated with the live streaming client and determine, based on the client attribute(s), whether the live streaming client is capable of rendering pixel-based video based on vector graphics data (i.e., whether the live streaming client includes the necessary hardware and/or software to render pixel-based video based on vector graphics data). As another example, the request from the live streaming client may explicitly request a vector graphics format. As yet another example, the live streaming client may initially broadcast live streams in a default vector graphics format and switch to another format if a format-switching condition is detected.

In an embodiment, if the live streaming client is incapable of vector-based video rendering, and/or if the live streaming server otherwise determines that the live streaming client should receive a pixel-based video (e.g., based on a default setting and/or a request by the live streaming client for a pixel-based video), then the live streaming server transmits pixel-based video to the live streaming client (Operation 220). If the live streaming client is capable of vector-based video rendering, and/or if the live streaming server otherwise determines that the live streaming client should receive a vector graphics-based live stream (e.g., based on a default setting and/or a request by the live streaming client for a vector-based graphics format), then the live streaming server transmits vector graphics data to the live streaming client (Operation 222). In an embodiment, while broadcasting the live stream with vector graphics data to the live streaming client, the live streaming server determines whether a format-switching condition is detected (Operation 224). As long as a format-switching condition is not detected and the live stream is ongoing, the live streaming server continues to broadcast the live stream with vector graphics data to the live streaming client (Operation 222). However, if a format-switching condition is detected, then the live streaming server may switch to transmitting pixel-based video to the live streaming client (Operation 220).

In an embodiment, while broadcasting the live stream with pixel-based video to the client, the live streaming server determines whether a format-switching condition is detected (Operation 226). As long as a format-switching condition is not detected and the live stream is ongoing, the live streaming server continues to broadcast the live stream with pixel-based video to the live streaming client (Operation 220). However, if a format-switching condition is detected, then the live streaming server may switch to transmitting vector graphics data (Operation 222). For example, if performance at the live-streaming client improves such that the live streaming client is now capable of rendering video based on vector graphics data, the live streaming server may switch to transmitting vector graphics data to the live streaming client.

3. Miscellaneous

In an embodiment, a system includes one or more devices, including one or more hardware processors, that are configured to perform any of the operations described herein and/or recited in any of the claims.

In an embodiment, one or more non-transitory computer-readable storage media store(s) instructions that, when executed by one or more hardware processors, cause performance of any of the operations described herein and/or recited in any of the claims.

Any combination of the features and functionalities described herein may be used in accordance with an embodiment. In the foregoing specification, embodiments have been described with reference to numerous specific details that may vary from implementation to implementation. Accordingly, the specification and figures are to be regarded in an illustrative rather than a restrictive sense. The sole and exclusive indicator of the scope of the invention, and what is intended by the Applicant to be the scope of the invention, is the literal and equivalent scope of the set of claims that issue from this application, in the specific form in which such claims issue, including any subsequent correction.

4. Computing Devices

In an embodiment, techniques described herein are implemented by one or more special-purpose computing devices (i.e., computing devices specially configured to perform certain functionality). The special-purpose computing device(s) may be hard-wired to perform the techniques and/or may include digital electronic devices such as one or more application-specific integrated circuits (ASICs), field programmable gate arrays (FPGAs), and/or network processing units (NPUs) that are persistently programmed to perform the techniques. Alternatively or additionally, a computing device may include one or more general-purpose hardware processors programmed to perform the techniques pursuant to program instructions in firmware, memory, and/or other storage. Alternatively or additionally, a special-purpose computing device may combine custom hard-wired logic, ASICs, FPGAs, or NPUs with custom programming to accomplish the techniques. A special-purpose computing device may include a desktop computer system, portable computer system, handheld device, networking device, and/or any other device(s) incorporating hard-wired and/or program logic to implement the techniques.

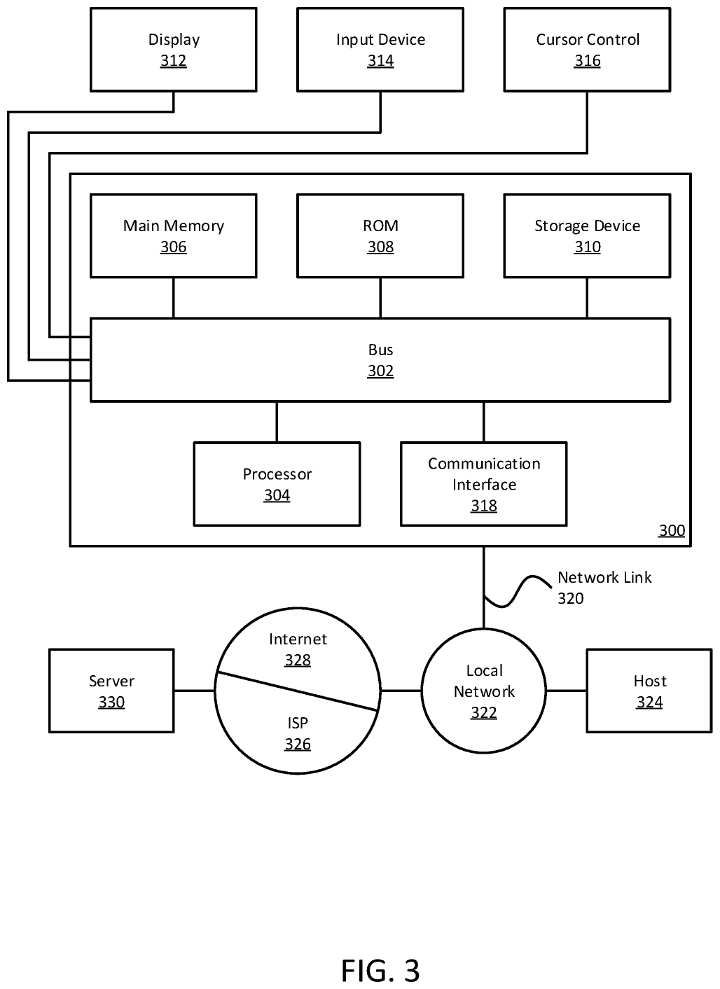

For example, FIG. 3 is a block diagram of an example of a computer system 300 according to an embodiment. Computer system 300 includes a bus 302 or other communication mechanism for communicating information, and a hardware processor 304 coupled with the bus 302 for processing information. Hardware processor 304 may be a general-purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in one or more non-transitory storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a liquid crystal display (LCD), plasma display, electronic ink display, cathode ray tube (CRT) monitor, or any other kind of device for displaying information to a computer user. An input device 314, including alphanumeric and other keys, may be coupled to bus 302 for communicating information and command selections to processor 304. Alternatively or additionally, computer system 300 may receive user input via a cursor control 316, such as a mouse, a trackball, a trackpad, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane. Alternatively or additionally, computer system 3 may include a touchscreen. Display 312 may be configured to receive user input via one or more pressure-sensitive sensors, multi-touch sensors, and/or gesture sensors. Alternatively or additionally, computer system 300 may receive user input via a microphone, video camera, and/or some other kind of user input device (not shown).

Computer system 300 may implement the techniques described herein using customized hard-wired logic, one or more ASICs or FPGAs, firmware, and/or program logic which in combination with other components of computer system 300 causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. Alternatively or additionally, hard-wired circuitry may be used in place of or in combination with software instructions.

The term “storage media” as used herein refers to one or more non-transitory media storing data and/or instructions that cause a machine to operate in a specific fashion. Such storage media may comprise non-volatile media and/or volatile media. Non-volatile media includes, for example, optical or magnetic disks, such as storage device 310. Volatile media includes dynamic memory, such as main memory 306. Common forms of storage media include, for example, a floppy disk, a flexible disk, hard disk, solid state drive, magnetic tape or other magnetic data storage medium, a CD-ROM or any other optical data storage medium, any physical medium with patterns of holes, a RAM, a programmable read-only memory (PROM), an erasable PROM (EPROM), a FLASH-EPROM, non-volatile random-access memory (NVRAM), any other memory chip or cartridge, content-addressable memory (CAM), and ternary content-addressable memory (TCAM).

A storage medium is distinct from but may be used in conjunction with a transmission medium. Transmission media participate in transferring information between storage media. Examples of transmission media include coaxial cables, copper wire, and fiber optics, including the wires that comprise bus 302. Transmission media may also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid state drive of a remote computer. The remote computer may load the instructions into its dynamic memory and send the instructions over a network, via a network interface controller (NIC), such as an Ethernet controller or Wi-Fi controller. A NIC local to computer system 300 may receive the data from the network and place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322, and communication interface 318.

The received code may be executed by processor 304 as it is received, and/or stored in storage device 310, or other non-volatile storage for later execution.

5. Computer Networks

In an embodiment, a computer network provides connectivity among a set of nodes running software that utilizes techniques as described herein. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (for example, a request to execute a particular application and/or retrieve a particular set of data). A server process responds by executing the requested service and/or returning corresponding data.

A computer network may be a physical network, including physical nodes connected by physical links. A physical node is any digital device. A physical node may be a function-specific hardware device. Examples of function-specific hardware devices include a hardware switch, a hardware router, a hardware firewall, and a hardware NAT. Alternatively or additionally, a physical node may be any physical resource that provides compute power to perform a task, such as one that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (for example, a physical network). Each node in an overlay network corresponds to a respective node in the underlying network. Accordingly, each node in an overlay network is associated with both an overlay address (to address the overlay node) and an underlay address (to address the underlay node that implements the overlay node). An overlay node may be a digital device and/or a software process (for example, a virtual machine, an application instance, or a thread) A link that connects overlay nodes may be implemented as a tunnel through the underlying network. The overlay nodes at either end of the tunnel may treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources may be shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). In a hybrid cloud, a computer network includes a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, a system supports multiple tenants. A tenant is a corporation, organization, enterprise, business unit, employee, or other entity that accesses a shared computing resource (for example, a computing resource shared in a public cloud). One tenant (through operation, tenant-specific practices, employees, and/or identification to the external world) may be separate from another tenant. The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In an embodiment, in a multi-tenant computer network, tenant isolation is implemented to ensure that the applications and/or data of different tenants are not shared with each other. Various tenant isolation approaches may be used. In an embodiment, each tenant is associated with a tenant ID. Applications implemented by the computer network are tagged with tenant IDs. Additionally or alternatively, data structures and/or datasets, stored by the computer network, are tagged with tenant IDs. A tenant is permitted access to a particular application, data structure, and/or dataset only if the tenant and the particular application, data structure, and/or dataset are associated with a same tenant ID. As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants. A subscription list may indicate which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels may be used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

What is claimed is:

1. One or more non-transitory computer-readable media storing instructions that, when executed by one or more processors, cause:
receiving, by a live streaming server while a video game is executing on a user device, a first set of unrendered vector graphics data that encodes three-dimensional graphics of the video game; and
transmitting, by the live streaming server, the first set of unrendered vector graphics data to a first live streaming client.

2. The one or more non-transitory computer-readable media of claim 1, further storing instructions that, when executed by one or more processors, cause:
prior to transmitting the first set of unrendered vector graphics data to the first live streaming client, transpiling, by the live streaming server, the first set of unrendered vector graphics data from a received data format to a normalized data format.

3. The one or more non-transitory computer-readable media of claim 1, further storing instructions that, when executed by one or more processors, cause:
installing, on the user device, a set of compiled code configured to intercept unrendered vector graphics data in calls to a graphics library.

4. The one or more non-transitory computer-readable media of claim 3, wherein the set of compiled code comprises a modified version of at least part of the graphics library.

5. The one or more non-transitory computer-readable media of claim 1, further storing instructions that, when executed by one or more processors, cause:
intercepting the first set of unrendered vector graphics data in a call to a graphics library on the user device; and
responsive to intercepting the first set of unrendered vector graphics data, transmitting the first set of unrendered vector graphics data from the user device to the live streaming server.

6. The one or more non-transitory computer-readable media of claim 1, further storing instructions that, when executed by one or more processors, cause:
receiving, by the live streaming server while the video game is executing, a second set of unrendered vector graphics data that encodes two-dimensional elements of a user interface of the user device; and
transmitting, by the live streaming server, the second set of unrendered vector graphics data to the first live streaming client.

7. The one or more non-transitory computer-readable media of claim 6, further storing instructions that, when executed by one or more processors, cause:
prior to transmitting the second set of unrendered vector graphics data to the first live streaming client, transpiling, by the live streaming server, the second set of unrendered vector graphics data from a received data format to a normalized data format.

8. The one or more non-transitory computer-readable media of claim 6, further storing instructions that, when executed by one or more processors, cause:
prior to transmitting the first set of normalized unrendered vector graphics data and the second set of normalized unrendered vector graphics data to the first live streaming client, aggregating, by the live streaming server, the first set of unrendered vector graphics data and the second set of unrendered vector graphics data.

9. The one or more non-transitory computer-readable media of claim 6, further storing instructions that, when executed by one or more processors, cause:
intercepting the second set of unrendered vector graphics data in a call to a graphics library on the user device; and
responsive to intercepting the second set of unrendered vector graphics data, transmitting the second set of unrendered vector graphics data from the user device to the live streaming server.

10. The one or more non-transitory computer-readable media of claim 1, further storing instructions that, when executed by one or more processors, cause:
installing a patch to the video game, the patch comprising a set of compiled code configured to transmit the set of unrendered vector graphics data generated by the video game to the live streaming server.

11. The one or more non-transitory computer-readable media of claim 1, further storing instructions that, when executed by one or more processors, cause:
rendering, by the live streaming server while the video game is executing, a video in a pixel-based format based at least on the first set of unrendered vector graphics data; and
transmitting, by the live streaming server, the video in the pixel-based video format to a second live streaming client for viewing.

12. The one or more non-transitory computer-readable media of claim 11, further storing instructions that, when executed by one or more processors, cause:
receiving, by the live streaming server while the video game is executing, a second set of unrendered vector graphics data that encodes two-dimensional elements of a user interface of the user device,
wherein rendering the video in the pixel-based format is further based on the second set of unrendered vector graphics data, such that the video in the pixel-based format simultaneously depicts the three-dimensional graphics of the video game and the two-dimensional elements of the user interface.

13. The one or more non-transitory computer-readable media of claim 11,
wherein transmitting the first set of unrendered vector graphics data to the first live streaming client is based at least on a first client attribute associated with the first live streaming client, and
wherein transmitting the video in the pixel-based format to the second live streaming client is based at least on the second client attribute associated with the second live streaming client.

14. The one or more non-transitory computer-readable media of claim 13, wherein the first client attribute indicates a first rendering capability of the first live streaming client and the second client attribute indicates a second rendering capability of the second live streaming client.

15. The one or more non-transitory computer-readable media of claim 1, further storing instructions that, when executed by one or more processors, cause:
detecting a format-switching condition associated with the first live streaming client; and
responsive to detecting the format-switching condition, transmitting video in a pixel-based video format to the first live streaming client instead of unrendered vector graphics data.

16. A system comprising:
at least one device including a hardware processor;
the system being configured to perform operations comprising:
receiving, by a live streaming server while a video game is executing on a user device, a first set of unrendered vector graphics data that encodes three-dimensional graphics of the video game; and
transmitting, by the live streaming server, the first set of unrendered vector graphics data to a first live streaming client.

17. The system of claim 16, the operations further comprising:
prior to transmitting the first set of unrendered vector graphics data to the first live streaming client, transpiling, by the live streaming server, the first set of unrendered vector graphics data from a received data format to a normalized data format.

18. The system of claim 16, the operations further comprising:
installing, on the user device, a set of compiled code configured to intercept unrendered vector graphics data in calls to a graphics library.

19. The system of claim 18, wherein the set of compiled code comprises a modified version of at least part of the graphics library.

20. The system of claim 16, the operations further comprising:
intercepting the first set of unrendered vector graphics data in a call to a graphics library on the user device; and
responsive to intercepting the first set of unrendered vector graphics data, transmitting the first set of unrendered vector graphics data from the user device to the live streaming server.

21. The system of claim 16, the operations further comprising:
receiving, by the live streaming server while the video game is executing, a second set of unrendered vector graphics data that encodes two-dimensional elements of a user interface of the user device; and
transmitting, by the live streaming server, the second set of unrendered vector graphics data to the first live streaming client.

22. The system of claim 21, the operations further comprising:
prior to transmitting the second set of unrendered vector graphics data to the first live streaming client, transpiling, by the live streaming server, the second set of unrendered vector graphics data from a received data format to a normalized data format.

23. The system of claim 21, the operations further comprising:
prior to transmitting the first set of normalized unrendered vector graphics data and the second set of normalized unrendered vector graphics data to the first live streaming client, aggregating, by the live streaming server, the first set of unrendered vector graphics data and the second set of unrendered vector graphics data.

24. The system of claim 21, the operations further comprising:
intercepting the second set of unrendered vector graphics data in a call to a graphics library on the user device; and
responsive to intercepting the second set of unrendered vector graphics data, transmitting the second set of unrendered vector graphics data from the user device to the live streaming server.

25. The system of claim 16, the operations further comprising:
installing a patch to the video game, the patch comprising a set of compiled code configured to transmit the set of unrendered vector graphics data generated by the video game to the live streaming server.

26. The system of claim 16, the operations further comprising:
rendering, by the live streaming server while the video game is executing, a video in a pixel-based format based at least on the first set of unrendered vector graphics data; and
transmitting, by the live streaming server, the video in the pixel-based video format to a second live streaming client for viewing.

27. The system of claim 26, the operations further comprising:
receiving, by the live streaming server while the video game is executing, a second set of unrendered vector graphics data that encodes two-dimensional elements of a user interface of the user device,
wherein rendering the video in the pixel-based format is further based on the second set of unrendered vector graphics data, such that the video in the pixel-based format simultaneously depicts the three-dimensional graphics of the video game and the two-dimensional elements of the user interface.

28. The system of claim 26,
wherein transmitting the first set of unrendered vector graphics data to the first live streaming client is based at least on a first client attribute associated with the first live streaming client, and
wherein transmitting the video in the pixel-based format to the second live streaming client is based at least on the second client attribute associated with the second live streaming client.

29. The system of claim 28, wherein the first client attribute indicates a first rendering capability of the first live streaming client and the second client attribute indicates a second rendering capability of the second live streaming client.

30. The system of claim 16, the operations further comprising:
detecting a format-switching condition associated with the first live streaming client; and
responsive to detecting the format-switching condition, transmitting video in a pixel-based video format to the first live streaming client instead of unrendered vector graphics data.

31. A method comprising:
receiving, by a live streaming server while a video game is executing on a user device, a first set of unrendered vector graphics data that encodes three-dimensional graphics of the video game; and
transmitting, by the live streaming server, the first set of unrendered vector graphics data to a first live streaming client,
wherein the method is performed by at least one device comprising a hardware processor.

32. The method of claim 31, further comprising:
prior to transmitting the first set of unrendered vector graphics data to the first live streaming client, transpiling, by the live streaming server, the first set of unrendered vector graphics data from a received data format to a normalized data format.

33. The method of claim 31, further comprising:
installing, on the user device, a set of compiled code configured to intercept unrendered vector graphics data in calls to a graphics library.

34. The method of claim 33, wherein the set of compiled code comprises a modified version of at least part of the graphics library.

35. The method of claim 31, further comprising:
intercepting the first set of unrendered vector graphics data in a call to a graphics library on the user device; and
responsive to intercepting the first set of unrendered vector graphics data, transmitting the first set of unrendered vector graphics data from the user device to the live streaming server.

36. The method of claim 31, further comprising:
receiving, by the live streaming server while the video game is executing, a second set of unrendered vector graphics data that encodes two-dimensional elements of a user interface of the user device; and
transmitting, by the live streaming server, the second set of unrendered vector graphics data to the first live streaming client.

37. The method of claim 36, further comprising:
prior to transmitting the second set of unrendered vector graphics data to the first live streaming client, transpiling, by the live streaming server, the second set of unrendered vector graphics data from a received data format to a normalized data format.

38. The method of claim 36, further comprising:
prior to transmitting the first set of normalized unrendered vector graphics data and the second set of normalized unrendered vector graphics data to the first live streaming client, aggregating, by the live streaming server, the first set of unrendered vector graphics data and the second set of unrendered vector graphics data.

39. The method of claim 36, further comprising:
intercepting the second set of unrendered vector graphics data in a call to a graphics library on the user device; and
responsive to intercepting the second set of unrendered vector graphics data, transmitting the second set of unrendered vector graphics data from the user device to the live streaming server.

40. The method of claim 31, further comprising:
installing a patch to the video game, the patch comprising a set of compiled code configured to transmit the set of unrendered vector graphics data generated by the video game to the live streaming server.

41. The method of claim 31, further comprising:
rendering, by the live streaming server while the video game is executing, a video in a pixel-based format based at least on the first set of unrendered vector graphics data; and
transmitting, by the live streaming server, the video in the pixel-based video format to a second live streaming client for viewing.

42. The method of claim 41, further comprising:
receiving, by the live streaming server while the video game is executing, a second set of unrendered vector graphics data that encodes two-dimensional elements of a user interface of the user device,
wherein rendering the video in the pixel-based format is further based on the second set of unrendered vector graphics data, such that the video in the pixel-based format simultaneously depicts the three-dimensional graphics of the video game and the two-dimensional elements of the user interface.

43. The method of claim 41,
wherein transmitting the first set of unrendered vector graphics data to the first live streaming client is based at least on a first client attribute associated with the first live streaming client, and
wherein transmitting the video in the pixel-based format to the second live streaming client is based at least on the second client attribute associated with the second live streaming client.

44. The method of claim 43, wherein the first client attribute indicates a first rendering capability of the first live streaming client and the second client attribute indicates a second rendering capability of the second live streaming client.

45. The method of claim 31, further comprising:
detecting a format-switching condition associated with the first live streaming client; and
responsive to detecting the format-switching condition, transmitting video in a pixel-based video format to the first live streaming client instead of unrendered vector graphics data.
